(19) United States
(12) Patent Application Publication
(10) Pub. No.: US 2014/0280776 A1
(43) Pub. Date: Sep. 18, 2014

(54) SCALABLE SYSTEM AND METHODS FOR PROCESSING IMAGE DATA

(71) Applicant: Invenshure, LLC, Minneapolis, MN (US)

(72) Inventors: Andrew Altepeter, Minneapolis, MN (US); Erik Anderson, Blaine, MN (US); Mark Caufman, Plymouth, MN (US); Ryan Chamberlain, Maplewood, MN (US); Jason Sheard, Maple Grove, MN (US)

(73) Assignee: Invenshure, LLC, Minneapolis, MN (US)

(21) Appl. No.: 14/205,455

(22) Filed: Mar. 12, 2014

Related U.S. Application Data
(60) Provisional application No. 61/783,622, filed on Mar. 14, 2013.
(60) Provisional application No. 61/788,108, filed on Mar. 15, 2013.

(51) Int. Cl. H04L 29/08

(52) U.S. Cl. CPC H04L 67/06
USPC 709/219

(57) ABSTRACT

A scalable system for processing image data may include a server system configured for processing medical image data relating to a patient, the server system being in communication with a network and configured for providing a user interface that is accessible by a user over the network and that is configured to allow the user to upload the medical image data for processing by the server system, the server system having at least one server for managing the uploading and processing of the medical image data, a scalable storage component in communication with the at least one server and configured to increase storage capacity as increasing quantities of medical image data is uploaded, and a scalable processing component in communication with the at least one server and configured to increase processing capacity as more data is processed.

### CROSS-REFERENCE TO RELATED APPLICATIONS

The present application claims priority to U.S. Provisional Patent Application No. 61/783,622 entitled Scalable System and Methods for Processing Image Data filed on Mar. 14, 2013 and U.S. Provisional Patent Application No. 61/788,108 entitled Scalable System and Methods for Processing Image Data filed on Mar. 15, 2013, the contents of which are hereby incorporated by reference in their entireties.

### TECHNICAL FIELD

The present application relates to processing of image data. More particularly, the present application relates to client/server-based processing of image data such as image data obtained from a computed tomography (CT) scan, a magnetic resonance imaging (MRI) scan, or a positron emission tomography (PET) scan. Still more particularly, the present application relates to efficient, on-demand, client/server-based, and scalable processing of the image data.

### BACKGROUND

When clinicians, radiologists, or researchers wish to process imaging data, for example data collected from an imaging device such as CT, MRI, PET, or any other imaging device, they will typically either send the data to a third party vendor, or will process the data in-house, for example in the hospital or the lab on a local workstation. Sending data to a vendor may be problematic in some cases because it may be relatively expensive. Further, a third party vendor may have limitations on how the data may be processed, including what algorithms may be used to process the data and/or the third party vendor may not be able to process the data in as timely a fashion as desired. Similarly, processing imaging data in-house may be less than ideal where multiple processing events need to happen in parallel because of the computing power generally needed to process such data and/or the time required for a user to interact with the processing application. Additionally, the software and hardware required to process imaging data may be cost prohibitive, particularly where there is not a great demand for processed image data. Accordingly, there is a need for a cost-effective, scalable, customizable way to have image data processed.

### SUMMARY

In some embodiments, a scalable system for processing image data may include a server system configured for processing medical image data relating to a patient. The server system may be in communication with a network and configured for providing a user interface that is accessible by a user over the network. The user interface may also be configured to allow the user to upload the medical image data for processing by the server system. The server system may include at least one server for managing the uploading and processing of the medical image data. The server system may also include a scalable storage component in communication with the at least one server and configured to increase storage capacity as increasing quantities of medical image data are uploaded. The server system may also include a scalable processing component in communication with the at least one server and configured to increase processing capacity as more data is processed.

In other embodiments, a method for processing medical image data regarding a patient may include presenting a user interface accessible by a user over a network. The method may also include uploading image data from a user via the user interface and storing the image data in a scalable data storage component. The method may also include receiving instructions to process the image data file from the user via the user interface and the instructions may include an indication of an algorithm to be used to process the image data file. The method may also include processing the image data with the algorithm using a scalable processing component with discrete compute instances. The method may also include capturing results of the processing and providing the results to the user. All along, a storage capacity of the scalable data storage component and a processing capacity of the scalable processing component may be increased and decreased based on the demand for image data processing.

### BRIEF DESCRIPTION OF FIGURES

FIG. 1 is a system schematic diagram, according to some embodiments.

FIG. 2 is a system diagram of the system of FIG. 1, according to some embodiments.

FIG. 3 is a detailed system diagram of the system of FIGS. 1 and 2, according to some embodiments.

FIG. 4 is an uploading sequence diagram performable by portions of the system of FIG. 1, according to some embodiments.

FIG. 5 is a job creation sequence diagram performable by portions of the system of FIG. 1, according to some embodiments.

FIG. 6 is a job processing sequence diagram performable by portions of the system of FIG. 1, according to some embodiments.

FIG. 7 is an options diagram depicting several options for client interaction with the system processing engine, according to some embodiments.

### DETAILED DESCRIPTION

The present disclosure in some embodiments may include a system and method for processing imaging data in a controlled, on-demand, efficient, and scalable way. The system may be a cloud-based system allowing a user to access the system via a network allowing the user to access the system at a time convenient for them and with a high level of control over the way in which the imaging data is processed. Such a cloud-based system may be hosted by the system provider's data center or on a third party's cloud-based system. In other embodiments, the system may also be hosted within a user's data center on their local area network (LAN), for example. The system may include an architecture particularly adapted for carefully managing the uploading and processing of data to maintain a fast and efficient system during both low and high demand episodes. In addition to the architecture, the system may include storage and processing systems that are supported by on-demand scalable systems such that the number of users and the amount of processing being requested at any given time may be accommodated by dynamically increasing and decreasing the amount of storage capacity and processing capacity of the system.

A user of the system may access a website via a web browser run by a processing provider, whereby the user may upload imaging data for processing. For example, the user may upload CT, MRI, or PET images. In some embodiments, a user may also upload a particular algorithm that should be used to process the data. The system may process the imaging data and may return a report. For example, the system may analyze the images diagnostically for evidence of conditions or diseases. The analysis, may for example, identify biomarkers of chronic obstructive pulmonary disease (COPD) or other conditions identifiable by analyzing the imaging data. The system architecture and the scalable aspects of the system may allow the storage capacity and processing capacity to increase or decrease together with the demand for the system allowing for multiple users to rely on the system for image data processing without the user realizing the burden on the system.

The present system may, thus, address many problems with current systems. That is, in comparison to current onsite systems, the user of the present system may avoid the investment and maintenance costs of the hardware and software of a system to process imaging data. In addition, the user may avoid issues of onsite backlogs and slow processing times when several imaging data projects are requested within a short period of time. In comparison to offsite systems, the user of the present system may be provided with more control of the running of the analysis both with respect to the algorithm that is used, but also with respect to the timing of the analysis. That is, the user may login to the system and run the analysis immediately without delay relating to backlog or sending the project offsite. Still further, while current offsite systems may have a high processing power, a user of the present system may be able to count on efficient processing speeds due to the ability of the system to increase its capacity on an as-needed basis. This allows the system to be larger or smaller than current systems at any given time based on demand. Accordingly, a user of the present system may enjoy both the control of current onsite systems while also enjoying the power of offsite systems. Moreover, the present system may allow the user to count on fast and efficient processing, which, from time to time, may not have been available in current onsite or offsite systems.

Referring now to FIG. 1, a schematic of an image data processing system 100 is shown in communication with a network 50. The system 100 is also in communication with a user 52 via the network 50. In some embodiments, the user 52 may be a clinician, physician, radiologist, technician, or other medically affiliated individual at a hospital, clinic, surgery center, or other medical diagnostic or care facility. The system 100 may be available to the user 52 via the network 50 such as, for example, the Internet. The system 100 may allow the user 52 to upload image data such as medical image data from a CT scan, MRI scan, or PET scan, for example. The system 100 may include a management component 102, a storage component 104, and a processing component 106. The system may facilitate storage of the image data and the size of the storage component 104 in the system 100 may be determined by the demand on the system. That is, the system may incorporate or unincorporate storage elements 108 on an on-demand basis such that this storage component resource of the system 100 may increase and/or decrease in capacity as the resource is used. Similarly, the processing capacity of the processing component 106 may increase and decrease by incorporating or unincorporating processing elements 110 on an on-demand basis such that this processing component resource of the system 100 may increase and/or decrease in capacity as the resource is used. The system 100 may function to process imaging data using a selected algorithm and the system 100 may include a particularly adapted architecture for such processing.

FIG. 2 shows a view of the system architecture for the image data processing system 100 and FIG. 3 shows a more detailed view thereof As shown, the system 100 may include a series of servers particularly adapted for image data processing. The system may include a front-end 112 server in communication with a system processing engine 114. The processing engine 114 may include a core server 116, a media server 118, an uploads server 120, a backend server 122, one or more utility nodes 124, one or more compute nodes 126, and a scalable storage component 128. In some embodiments, the front end server may be incorporated into the core server either physically and/or functionally and, thus, may be a part of the system processing engine. In comparison to FIG. 1, several aspects of the system architecture may be included in the management component 102 such as the several servers. Several aspects of the system architecture may be included in the storage component 104 such as the sealable storage component 128 and the several SQL storage elements or other databases. Several aspects of the system architecture may be included in the processing component such as the parsing utility 124 nodes and compute instances.

Referring again to FIGS. 2 and 3, each of these servers and/or nodes may be particularly adapted to perform a particular aspect of image data processing. As a whole, the system 100 may be adapted to process image data jobs from one or more users simultaneously and over a network 50. In particular, the system 100 may include one or a plurality of utility/compute nodes or instances 124, 126, based on demand, and each isolated from one another and dedicated and available for processing a particular job such that an increasing number of jobs does not slow the processing speed. The system architecture and the utility/compute nodes/instances 124, 126 in conjunction with the scalable data storage system 128 may function to provide a very powerful system 100 for efficiently processing image data and allowing the system 100 to increase or decrease in size on an as-needed basis.

The front-end server 112 may be adapted for interaction with a user 52 and for communicating with the system processing engine 114. The front-end server 112 may, thus, be configured for presenting the user 52 with a user interface 130 via the network 50 (e.g., over the Internet). That is, the front-end server 112 may be configured to provide a website via a network 50 such that a user 52 may interact with the system 100 to upload and control processing of the image data.

The user interface 130 may include a login screen prompting the user 52 to provide a username and password for accessing the system 100. The user interface 130 may also include an upload component allowing the user to upload image data files such as, for example, digital imaging and communications in medicine (DICOM) imaging files. In addition, the user interface 130 may include navigation and management component allowing the user to review, organize, and maintain the uploaded data. In addition, the user interface 130 may include a processing component allowing the user to start processing jobs on selected data with selected algorithms and monitor the processing jobs. In some embodiments, for example, the user interface 130 may prompt the user 52 with a list of algorithms or prompt the user 52 to navigate through a series of dialogue box selections to arrive at a selected algorithm. In some embodiments, the user interface 130 may allow a user to provide the algorithm to run on the image data and, as such, may prompt the user 52 to upload the algorithm, for example. The user interface 130 may also include an output component allowing the user 52 to review and/or download the job output when the system 100 is finished processing the image data. In addition, the user interface 130 may include an account component allowing the user 52 to manage account settings and adjust preferences affecting event-based e-mail communication.

As the user's window to the system 100, the front-end server 112 may also be configured to interact with the system processing engine 114 to both receive information and instruct or control the system processing engine 114. That is, the front-end server 112 may query the system processing engine 114 for the state of the system 100 and may also control the system processing engine 114 using particularly adapted application programming interfaces (API's). For example, for any given interface component, the front-end 112 server may communicate with the system processing engine 114 via an API adapted to support the particular interface. For example, where the navigation and management component is being used to view data, a data viewing API may be used to interact with the system processing engine 114 to provide the relevant data. As such, the front-end server 112 may be supported by the system processing engine 114 when the front-end server 112 is receiving data uploads, when data such as DICOM data sets, algorithms, or jobs are being navigated, when data is being viewed, when data is being downloaded, when client accounts are being accessed and managed, and when jobs are being initiated. The front-end 112 may also receive notifications from the system processing engine 114 regarding status updates, new data identification, when downloads are available.

In some cases, the front-end server 112 may be configured for facilitating communication and interaction with particular aspects of the system processing engine 114. For example, the front-end server 112, in some embodiments may provide a user's browser with direct access to the uploads server 120 to transfer input data for processing. In other embodiments, the front-end server 112 may act as a proxy to temporary files generated on the uploads server 120. In still other embodiments, the front-end server 112 may act as a proxy to files hosted on the media server 118.

Turning now to the system processing engine 114 which the front-end server may or may not be a part of, the several particular servers and/or nodes may be described. With continued reference to FIGS. 2 and 3, the system processing engine 114 may include a core server 116. The core server 116 may be configured to be the entry point to the system processing engine 114. As mentioned with respect to the front-end server 112, the core server 114 may be in communication with the front-end 112 server to support the front-end servers several functionalities. The core server 116 may also be in communication with the back-end server 122 via a queue, for example. The core server 116 may maintain data about the algorithms and datasets being processed and may store this data in a database 123. In some embodiments, the core server 116 may be in communication with the utility and compute nodes 124, 126. The core server 116 may, thus, be a centralized server for supporting and managing the several servers and processes being conducted by the system 100. This may be in contrast to the front-end server 112 that may be focused on providing and presenting the user interface 130 and accepting image data downloads. This may also be in contrast to the back end server 122 that may be focused on processing and/or managing the processing of data. As such, in some embodiments, the core server 116 may be a central management server that may control the processes that are performed by the system processing engine 114. In one embodiment, the core server 116 may be hosted as an Amazon Web Service Elastic Compute server. Still other hosts may be provided.

The system processing engine 114 may also include a media server 118. The media server 118 may be particularly adapted for supporting a viewer aspect of the user interface 130. That is, for example, the user interface 130 presented by the front-end server 112 may include a viewer component particularly adapted for viewing sliced DICOM images. That is, the viewer may provide for viewing cross-sections of a patient organ, for example, and the media server 118 may be equipped particularly for providing these sliced DICOM images.

The system processing engine 114 may also include an uploads server 120. This server 120 may be particularly adapted to facilitate uploading of image data files. For example, the uploads server 120 may be in communication with the front-end server 112 such that the uploads server 120 may facilitate the uploading of files when the user interface is used by a user in this fashion. The uploads server 120 may receive the files via a browser of a user, for example, and may store the files in an on-demand and/or scalable storage facility 128 such as, for example, an Amazon S3 storage system. The uploads server 120 may communicate with the core server 116 to indicate that the files have been uploaded. This may trigger the core server 116 to instruct the parsing utility nodes 124 to parse the uploaded file or files. In some cases the upload may be automated using Picture Archiving and Communication System (PACS) or Vendor Neutral Archive (VNA) software integrated with a customer's local area network. In this embodiment, the system may be adapted to automatically upload and/or process the image data upon acquisition by the user.

It is to be appreciated that both of the media server 118 and the uploads server 120 may be physically part of the core server 116, but may be functionally separate. In other embodiments, each of the media server 118, the uploads server 120, and the core server 116 may be physically separate machines.

The parsing nodes 124 may be configured for managing the data upon being uploaded to the system 100. That is, the parsing nodes 124 may act on DICOM files, for example, that have been uploaded to the system 100. The parsing nodes 124 may format all of the metadata and image data creating suitable image data for processing with the system 100. The parsing nodes 124 may incorporate the uploaded image data files into a database 123 associated with the back-end server 122. Multiple parsing nodes 124 may be created to handle the amount of data being uploaded and incorporated into the database. The parsing nodes or instances 124 may be short-running, dynamically-provisioned, dynamically-terminated elastic compute cloud instances. As such, slowing of the system due to large or multiple uploads of large data files may be avoided due to the ability to create multiple parsing nodes 124 from an abundantly available resource allowing the system to expand to handle the load on an as-needed basis.

The back-end server 122 may be focused on processing of image data. However, the back-end server 122 itself may not process the image data, but may function as a dispatcher to direct processing by, for example, the compute instances 126. The back-end server 122 may, for example, receive a queue from the core server 116 for algorithm processing. The back-end server 122 may then create compute instances 126 to perform the data processing and the back-end server 122 may also communicate to the compute instance 126 what to process. It is to be appreciated that the back-end server 122 may be isolated from the compute instances 126 such that multiple compute instances 126 do not result in a load on the system 100 that would bog down the speed or efficiency of the system 100. Rather, as a dispatcher, the back-end server 122 may rely on abundantly available compute instances 126 that may be requested on an on-demand basis allowing the processing power of the system 100 to increase or decrease as needed. In one embodiment, the back-end server 122 may be hosted as an Amazon Web Service Elastic Compute server. Still other hosts may be provided.

As suggested, the compute instance or instances 126 may perform the algorithm processing. For a particular processing job, for example, the compute instance 126 may access the algorithm (i.e., selected or uploaded by the user) and the dataset (i.e., uploaded by the user) and the compute instance 126 may run the algorithm on the dataset. The compute instance 126 may upload the output to the core server 116 via the uploads server 120 and may communicate the algorithm status via the core server 116 to the front-end server 112 and, thus, the user interface 130. The algorithms may include code packages that meet the requirements/definitions for running on a Scripzo platform computer instance 126. The compute instances 126 may be short-running, dynamically-provisioned, dynamically-terminated elastic computer cloud instances. The compute instances 126 may be abundantly available and may be created on an as-needed basis so as to allow the system to increase in processing capacity on an as-needed basis.

The algorithms run by the system may include any algorithm for processing image data. In some embodiments, where patient issues relate to chronic obstructive pulmonary disease (COPD), for example, the algorithm may be particularly adapted to process images of the lungs. For example, the algorithm may be adapted to perform image segmentation, registration, and classification on CT images of human lungs. Segmentation may allow the lung portions of the images to be separated from the surrounding or rest of the body. Registration may allow for one lung image to be warped onto another such that the lungs can be compared three-dimensionally voxel-by-voxel. The classification aspect of the algorithm may allow the images during inhalation and exhalation to be compared. For example, each voxel may be classified based on how its Hounsfield Unit changed between inhale and exhale. Still other image processing algorithms may be used and may be provided on the system or the user may provide an algorithm for use in processing the image data.

In some cases algorithms may be known and/or proprietary algorithms. For example, algorithms directed to technology described in U.S. patent application Ser. No. 13/539,232, entitled, “Pixel and Voxel-Based Analysis of Registered Medical Images for Assessing Bone Integrity,” filed Jun. 29, 2012; U.S. Pat. No. 8,185,186, entitled, “Systems and Methods for Tissue Imaging,” issued May 22, 2012; U.S. Appln. No. “Systems and Methods for Tissue Imaging,” filed May 2, 2012; U.S. Pat. No. 13/539,254, entitled, “Tissue Phasic Classification Mapping System and Method,” filed Jun. 29, 2012; U.S. patent application Se. No. 13/683,746, entitled “Voxel-Based Approach for Disease Detection and Evolution,” filed Nov. 21, 2012, may be used with embodiments of the present disclosure, each of which is hereby incorporated by reference herein in its entirety. The uploading of image data and/or algorithms may be secure, in some cases encrypted, and in some cases may comply with Health Insurance Portability and Accountability Act (HIPAA) requirements.

In use, the above system 100 may allow a user such as a clinician, radiologist, researcher, or other type of user to gain access to imaging algorithms in a simple and scalable manner. That is, the user 52 may be able to supply input data by uploading it via the user interface 130. In some embodiments, the user may scrub the image data to remove any and all protected health information from the data before the data leaves the users local area network, for example. Such information may be restored when the results are returned and/or enter a user's local area network. A tracking ID or other tracking system may be provided by the system to match the data back up once it enters the users local area network. In addition, the user 52 may be able to start an imaging processing job by selecting the algorithm and the particular data the algorithm is to be run on. The user 52 may be able to configure the processing job and when the job is finished, the user 52 may access the results. All of this may able to be completed via the cloud, which is to say that the user 52 may access the user interface 130 via a web browser on a machine connected to the network 50. Moreover, the multiple users 52 may be able to access the system 100 at any given time and request processing at any given time. The system 100 may manage those requests and process those requests without delay due to volume of processing because of the scalability of the system 100. As such, the user 52 may have ready access to a reliable and efficient system for processing image data and may be able to control the processing of that data both with respect to the when the processing is performed and how it is performed.

FIGS. 4-6 include a series of sequence diagrams depicting the processing of the imaging data. In using the system 100, there may be at least three aspects included in creating a job including choosing a tool, selecting the data, and initiating the job. As shown, during the process, a number of states may be identifiable. For example, once a job is created with a unique identifier job may be in a state of “queuing 132.” A message may be sent to the back end server to initiate processing. The user interface may be updated to show that the job has been initiated. Upon receiving the job request, the back end queues the job and informs the core server that the state of the job is “queued 134.” In the queued state, the back end may receive the initiated job message and create a compute instance server. A separate compute instance may be created, for example, with Amazon's EC2 platform for each job. This allows for scalability to many simultaneous jobs.

Once the compute instance begins, it may receive a queued job message and may set the job status to “preparing 136.” In the preparing state, the compute instance may receive information to run the job from the core server including the full job information, the information about the tool/algorithm, and the keys in S3 for the tool code and input data. The computer instance may then retrieve the tool code from S3 and the input data from S3. It may then install the tool code.

The job state may now change to “running 138.” In the running state, the compute instance may run the installed tool using the input data. While running, the compute instance may capture the output. If the output contains properly formatted error or warning lines, these messages may be stored as a part of the job report properties.

Once the tool completes, the job state may change to “cleanup 140.” During the cleanup phase, the output data from the tool may be uploaded. The compute instance may utilize the core server to upload via the uploads server. The return code from the tool may be analyzed to determine whether the tool completed successfully or if it failed. The job's status may then be changed to “success” or “failure.” The core server may send a “job completed 142” message to the back end server to decommission the compute instance.

In addition to the scalability at the compute instances 126 and the parsing 124 aspects of the system 100, the isolation of the several servers and compartmentalized approach to managing the processes may help to avoid affecting a particular portion of the process while other portions of the process are being performed. For example, should the system 100 experience a high volume of users 52 that are accessing the user interface 130 to review results or manage processes, such activity being at least twice removed from the back end server 122 and three times removed from the compute instances 126 may help to insulate the processing from such activity. In another example, where multiple users 52 are uploading image data files, the isolated and separate uploads server 120 may isolate these high data management processes from the user interface 130, the front-end server 112, the core server 116, and the back end server 122. These are but a few examples of the compartmentalized and/or isolated architecture. However, it is to be appreciated that the each isolation shown in FIGS. 2 and 3, for example, may function to particularly isolate the activities on one server from affecting the speed and efficiency of the activities on an adjacent isolated server or a more distant isolated server.

Referring now to FIG. 7 in addition to allowing a single user 52 to upload and process image data, the cloud-based nature of the system may allow multiple users to collaborate and/or access a particular data set of series of data sets or algorithms. For example, in some embodiments, a user may allow others to view and/or access the data in original and/or results form or to access algorithms they have uploaded. In other embodiments, a user may provide access rights to a particular job or process such that others may be able to access and review the results, status, or other aspect of an imaging data process. In other embodiments, a user may allow access rights to an algorithm they have uploaded, so that another user can use that algorithm on data they have uploaded separately. Still other collaborative techniques may also be provided.

FIG. 7 also shows that a web browser is only one of many possible methods for user interaction. A client API is available that can be interacted with directly from an interactive shell such as Python or IPython. In other embodiments the API could be integrated into a custom client application by a user. In other embodiments the API could be used to create a plugin for popular image processing software applications such as OsiriX, ImageJ or 3D Slicer. These plugins would allow users that upload, view and download data from the platform from within the client application or to launch processing jobs from within the client application.

It is to be understood that the descriptions provided in this application are directed toward particular embodiments of the present disclosure and are in no way intended to be limiting. Other suitable software programs, algorithms, platforms, plug-ins, etc. than those described herein may be used with embodiments of the present disclosure.

In some embodiments, as mentioned, each specific job, or data processing event, may be performed on a dedicated server. Accordingly, each job may run independently from any other job, making the platform of the present disclosure fast and scalable. The output of the system may be one or more images and/or a report, for example, after the selected and/or provided algorithm has been used to process the uploaded image data. It will be understood, however, that the output may be any suitable output, such as a graph, chart, spreadsheet, or any other type of output.

As provided herein and in the accompanying documents, embodiments of the present disclosure may be advantageous to the user in that the user may have access to fast, scalable, customizable data processing. In some embodiments, the processing provider may also benefit from embodiments of the present disclosure by implementing a “pay-per-click” payment system, whereby a user may pay a fixed or negotiated rate for each job requested or completed. For example, the front-end server may include this as part of the user interface. This feature may also benefit the user that may not have enough need for the image processing to justify the purchase of expensive hardware and software to do the processing in-house. Further, even where a user may have enough demand to justify the cost of the software/hardware, in some cases the need may be so great that in-house applications simply will not be fast enough. Accordingly, embodiments of the present disclosure may advantageously provide a user with a scalable cost-effective and customizable solution for image processing.

Other payment methods are possible for the Processing Provider, including a monthly, weekly, yearly, etc. subscription fee, or any other suitable payment method or combination of payment methods.

It is to be appreciated that several foundational systems and arrangements may be used to implement the present system. For example, in some embodiments, all or a large majority of the system may be hosted by a third party system such as Amazon. However, in other embodiments, particular portions may be hosted by a provider of the cloud-based system and the third party may be relied on solely for the scalable aspects of the system. For example, in some embodiments, the front-end, the core, the uploads, the media, and the back end servers may all be hosted by the provider of the system and the compute instances, the parsing nodes, and the on-demand scalable database (i.e., the S3) may be hosted by a third party provider. In still other embodiments, the provider of the system may have a large enough system to host the entirety of the system, where, for example, the provider may allow other systems to access its in-house on-demand scalable database and processing system. In still other embodiments, users may host portions of the system. For example, a user such as a hospital or other medical system may host the front-end server allowing the user to control the user interface to a degree. Still other portions of the system may also be hosted by the user such as the core server, the media server, the uploads server, and the back end server. Still other aspects of the system may be hosted by the user. Hosting particular aspects of the system may be advantageous to a user for purposes of security, privacy, and/or medical regulation compliance.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of or “generally free of an ingredient or element may still actually contain such item as long as there is generally no measurable effect thereof.

While the present disclosure has been described with regard to image processing, it will be understood that the present disclosure may also apply to other industries or areas that have a need for data processing on a scalable, on-demand, customizable basis.

While certain embodiments have been described in detail, it will be understood that the present disclosure is not limited to such embodiments, but rather includes variations of features described, as well as combinations of features described, which are also included within the spirit and scope of the present invention.

What is claimed is:

1. A scalable system for processing image data, the system comprising:
a server system configured for processing medical image data relating to a patient, the server system being in communication with a network and configured for providing a user interface that is accessible by a user over the network and that is configured to allow the user to upload the medical image data for processing by the server system, the server system comprising:
at least one server for managing the uploading and processing of the medical image data;
a scalable storage component in communication with the at least one server and configured to increase storage capacity as increasing quantities of medical image data are uploaded; and
a scalable processing component in communication with the at least one server and configured to increase processing capacity as more data is processed.

2. The system of claim 1, wherein the scalable storage component is configured to decrease storage capacity as decreasing quantities of medical image data is uploaded.

3. The system of claim 1, wherein the scalable processing component is configured to decrease processing capacity as decreasing quantities of medical image data are processed.

4. The system of claim 1, wherein the processing component comprises a selected number of discrete compute instances where the number of compute instances varies depending on demand for processing.

5. The system of claim 4, wherein the image processing on the discrete compute instances is processed in parallel to facilitate efficient processing times.

6. The system of claim 1, wherein the user interface is configured to allow the user to selectively upload one or more algorithms for processing the medical image data.

7. The system of claim 1, wherein the server system comprises a front-end server configured for providing the user interface accessible by a web browser of the user.

8. The system of claim 7, wherein the server system comprises a back end server configured for dispatching jobs to the processing component.

9. The system of claim 8, wherein the server system comprises a core server configured for managing and facilitating communication between the front-end server and the back end server.

10. The system of claim 1, wherein the server system comprises an upload server configured for facilitating the direct uploading of the medical image data to the storage component.

11. The system of claim 1, wherein the medical image data includes image data from one of a CT scanner, an MRI scanner, and a PET scanner.

12. The system of claim 1, wherein the algorithm for the medical image processing relates to a medical condition of chronic obstructive pulmonary disease (COPD).

13. The system of claim 12, wherein the algorithm involves imaging biomarkers for COPD characterization.

14. The system of claim 1, wherein the server system is hosted outside a user's local area network.

15. The system of claim 14, wherein the server system is hosted by an entity other than the system provider and the user.

16. The system of claim 14, wherein the server system is hosted by the system provider.

17. The system of claim 1, wherein the server system is hosted on a user's local area network.

18. The system of claim 1, wherein the server system is adapted to automatically upload and process the medical image data upon acquisition of the medical image data by the user.

19. The system of claim 18, wherein the medical image data is devoid of protected health information.

20. A method for processing medical image data regarding a patient, the method comprising:
presenting a user interface accessible by a user over a network;
uploading image data from a user via the user interface and storing the image data in a scalable data storage component;
receiving instructions to process the image data file from the user via the user interface, the instructions including an indication of an algorithm to be used to process the image data file;
processing the image data with the algorithm using a scalable processing component with discrete compute instances;
capturing results of the processing; and
providing the results to the user,
wherein a storage capacity of the scalable data storage component and a processing capacity of the scalable processing component are increased and decreased based on the demand for image data processing.

21. The method of claim 20, further comprising receiving the algorithm from the user via the user interface.

22. The method of claim 20, further comprising receiving an algorithm selection from the user via the user interface.

23. The method of claim 20, wherein the medical image data includes image data from one of a CT scanner, an MRI scanner, and a PET scanner.

24. The method of claim 20, wherein the algorithm for the medical image processing relates to a medical condition of chronic obstructive pulmonary disease (COPD).

25. The method of claim 20, wherein the algorithm involves imaging biomarkers for COPD characterization.
